(19) United States
(12) Patent Application Publication
(10) Pub. No.: US 2014/0043603 A1
(43) Pub. Date: Feb. 13, 2014

(54) SURFACE INSPECTING APPARATUS HAVING DOUBLE RECIPE PROCESSING FUNCTION

(71) Applicant: HITACHI HIGH-TECHNOLOGIES CORPORATION, Tokyo (JP)

(72) Inventors: Yu YANAKA, Kamisato-machi (JP); Kiyotaka HORIE, Kamisato-machi (JP); Nobuyuki SUGIMOTO, Kamisato-machi (JP); Shigeru SERIKAWA, Kamisato-machi (JP)

(73) Assignee: HITACHI HIGH-TECHNOLOGIES CORPORATION, Tokyo (JP)

(21) Appl. No.: 13/956,465

(22) Filed: Aug. 1, 2013

(30) Foreign Application Priority Data
Aug. 10, 2012 (JP) 2012-177831

(51) Int. Cl. G01N 21/956

(52) U.S. Cl. CPC G01N 21/956
USPC 356/237.5

(57) ABSTRACT

In order to enable an evaluation for changing parameters without stopping the inspection of a magnetic disk in production lines, the surface inspecting apparatus illuminates a sample with light while rotating the sample and moving the same in a direction perpendicular to the axis of rotation, detects light reflected/scattered in a first direction from the sample illuminated with the light to obtain a first detection signal, detects light reflected/scattered in a second direction from the sample illuminated with the light to obtain a second detection signal, and a detection of a defect on the sample by processing the first detection signal and the second detection signal, based on a first inspection recipe and a detection of a defect on the sample by processing the first detection signal and the second detection signal, based on a second inspection recipe are performed to detect a defect on the sample.

### BACKGROUND

The present invention relates to an apparatus and method for optically inspecting flaws on the surface of a sample such as a magnetic disk and defects on the surface thereof such as foreign matters adhered thereto. The invention more particularly relates to a surface inspecting apparatus and method which has a double recipe processing function for inspecting the surface of a sample.

There is an apparatus which optically inspects flaws on the surface of a magnetic disk and defects such as foreign matters adhered thereto. Such an apparatus counts the type and size of each defect, and the number of defects for each type or size in association with the output of illumination, an inspection condition for defect detection, and the output from each detection system, and using a parameter list, finally determines whether the inspected disk is faulty or not. The parameter list (hereinafter described as recipe) therefore determines the quality and yield of each inspected disk. More experience and time were required to create the recipe.

An optical magnetic disk defect inspecting apparatus has been described in JP-2012-42375-A. This has disclosed a configuration in which receiving signals detected by detection optical systems, a signal processing/control system performs signal processing thereon to detect and classify defects, but has not described of parameters used in plural form for detecting and classifying the defects by performing the signal processing by means of the signal processing/control system.

### SUMMARY

In order to detect and classify the defects by performing the signal processing on the signals detected by the detection optical systems, changing the parameters for detecting and classifying the defects is done. This is work very important for the determination of the quality and yield of the inspected magnetic disk.

In the optical magnetic disk defect inspecting apparatus described in the JP-2012-42375-A, there is no description of the parameters used in plural form for detecting and classifying the defects by performing the signal processing by means of the signal processing/control system. Thus, when the parameters are changed in the optical magnetic disk defect inspecting apparatus described in the JP-2012-42375-A, the evaluation for changing the parameters must be carried out while the inspection of each magnetic disk in the production lines is temporarily stopped. Creating the recipe for changing the parameters is however needs experiences and time, thus leading to a substantial degradation in the operating rate of the apparatus in the production lines.

The present invention provides a surface inspecting apparatus having a double recipe processing function, which solves the problems included in the foregoing related art and is capable of performing an evaluation for changing parameters without stopping the inspection of each magnetic disk in production lines, and a method thereof.

In order to solve the above problems, the present invention provides a surface inspecting apparatus having a double recipe processing function. The surface inspecting apparatus comprises: a stage device rotatable with a disk as a sample placed thereon and movable in a direction perpendicular to the axis of rotation; an illuminating device which illuminates the sample placed on the stage device with light; a first detecting device which detects light reflected/scattered in a first direction from the sample illuminated with the light by the illuminating device; a second detecting device which detects light reflected/scattered in a second direction from the sample illuminated with the light by the illuminating device; a processing device which processes a first detection signal obtained by detecting the light reflected/scattered in the first direction from the sample by the first detecting device, and a second detection signal obtained by detecting the light reflected/scattered in the second direction from the sample by the second detecting device so as to detect a defect on the sample; and an output device which outputs a result of processing performed by the processing device. The processing device outputs to the output device a result obtained by processing the first detection signal and the second detection signal, based on a first inspection recipe to detect a defect on the sample, and a result obtained by processing the first detection signal and the second detection signal, based on a second inspection recipe to detect a defect on the sample.

Further, to solve the above problems, the present invention provides a surface inspecting method having a double recipe processing function. The surface inspecting method comprising: illuminating a sample with light while rotating a disk as the sample and moving the same in a direction perpendicular to the axis of rotation; detecting light reflected/scattered in a first direction form the sample illuminated with the light to obtain a first detection signal; detecting light reflected/scattered in a second direction from the sample illuminated with the light to obtain a second detection signal; and processing the first detection signal and the second detection signal to detect a defect on the sample. The detection of the defect on the sample includes a detection of a defect on the sample by processing the first detection signal and the second detection signal, based on a first inspection recipe and a detection of a defect on the sample by processing the first detection signal and the second detection signal, based on a second inspection recipe.

According to the present invention, the surface inspecting apparatus is provided with the double recipe processing function, thereby making it possible to perform an evaluation for changing parameters for the detection and classification of defects by the surface inspecting apparatus without stopping the inspection of a magnetic disk in production lines. It is therefore possible to create a novel recipe without degrading the operating rate of the surface inspecting apparatus.

These features and advantages of the invention will be apparent from the following more particular description of preferred embodiments of the invention, as illustrated in the accompanying drawings.

### BRIEF DESCRIPTION OF THE DRAWINGS

FIG. 1A is a block diagram showing a schematic configuration of a surface inspecting apparatus having a double recipe processing function according to an embodiment of the present invention;

FIG. 1B is a block diagram showing the configuration of a production processing section of a processor of the surface inspecting apparatus having the double recipe processing function according to the embodiment of the present invention;

FIG. 1C is a block diagram showing the configuration of an evaluation processing section of the processor of the surface inspecting apparatus having the double recipe processing function according to the embodiment of the present invention;

FIG. 2 is a plan view of a sample, showing an r direction and a θ direction on the surface of a sample in the embodiment of the present invention;

FIG. 3 is a flow diagram showing the flow of processing for performing a substrate rank decision in the embodiment of the present invention;

FIG. 4 is a display screen showing a result of execution of the substrate rank decision in the embodiment of the present invention; and

FIG. 5 is a display screen for adjusting evaluation inspection recipes in the embodiment of the present invention.

### DESCRIPTION OF THE PREFERRED EMBODIMENTS

The present invention provides a surface inspecting apparatus having a double recipe processing function. It is therefore possible to create a recipe for evaluation using the same inspection data as that for a recipe for production while performing the inspection of a magnetic disk in production lines using the recipe for production.

An embodiment of the present invention will hereinafter be described using the drawings.

First, a description will be made of a surface defect inspecting apparatus which checks the light amount level of regular reflection light or scattered light from a substrate illuminated with an illumination light to determine whether or not the substrate is a predetermined substrate simultaneously with a defect inspection of a substrate.

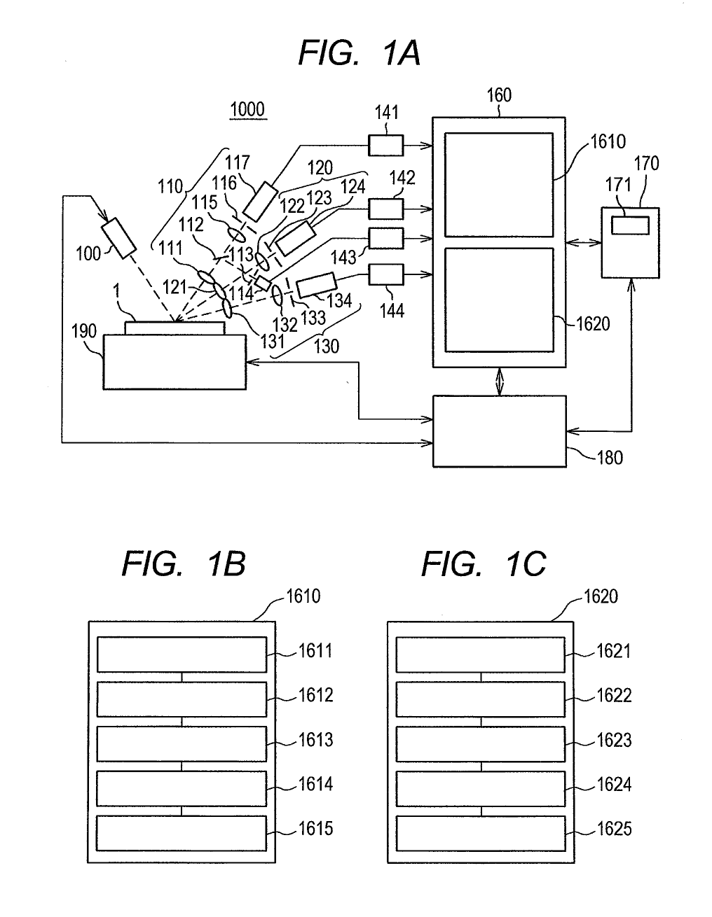

The schematic configuration of a surface defect inspecting apparatus 1000 according to the present embodiment is shown in FIG. 1A. A sample targeted for inspection is a substrate for a magnetic disk, which is formed of a glass material and whose surface is not coated with a thin film or the like and the glass material is exposed.

The surface defect inspecting apparatus 1000 is equipped with an illuminating device 100 which applies illumination light to a sample 1, a high-angle detection optical system 110 which gathers and detects light reflected and scattered in a high-angle direction from the sample 1 illuminated with the illumination light, a middle-angle detection optical system 120 which gathers and detects light scattered in a middle-angle direction from the sample 1, a low-angle detection optical system 130 which gathers and detects light scattered in a low-angle detection from the sample 1, a processing device 160 which processes the signals output from the respective detection optical systems by the detection of the lights, an input/output device 170 which inputs a processing condition for the processing device 160 therein and outputs the result of processing, an overall controller 180 which controls the entire apparatus, and a stage device 190 which moves the sample in one direction while rotating the same.

The illuminating device 100 is equipped with a laser light source which outputs laser having a desired wavelength.

The high-angle detection optical system 110 is an optical system which detects light, including regular reflection light, that is reflected/scattered from the surface of the sample 1 illuminated with the illuminating device 100 and advances in a high-angle direction, of the lights advancing in the directions indicated by broken lines. The high-angle detection optical system 110 is equipped with an objective lens 111 which gathers the reflected/scattered light including the regular reflection light that has advanced in the high-angle direction from the surface of the sample 1, a mirror 112 which reflects the regular reflection light from the sample 1, of the light converged by the objective lens 111, a pinhole plate 113 which has a pinhole for allowing the regular reflection light from the sample 1 reflected by the mirror 112 to pass therethrough and shields stray light other than the regular reflection light, a regular reflection light detector 114 which detects the regular reflection light having passed through the pinhole plate 113, a converging lens 115 which causes light (scattered light from the sample 1) not reflected by the mirror 112, of the light converted by the objective lens 111 to converge thereon, a pinhole plate 116 which has a pinhole that is placed at a convergence point of the converging lens 115 and causes the converged light to pass therethrough and which shields or blocks out light that is not converged, and a high-angle detector 117 which detects the light having passed through the pinhole plate 116.

The middle-angle detection optical system 120 is equipped with an objective lens 121 which gathers scattered light advanced in a middle-angle direction, of the light reflected/scattered from the surface of the sample 1 which is illuminated with the light from the illumination device 100, a converging lens 122 which causes the light gathered by the condensing lens 121 to converge, a pinhole plate 123 which has a pinhole that is placed at a convergence point of the converging lens 122 and causes the converged light to pass therethrough and which shields the unconverged light, and a middle-angle detector 124 which detects the light that has passed through the pinhole plate 123. The low-angle detection optical system 130 is equipped with an objective lens 131 which gathers scattered light advanced in a low-angle direction, of the light reflected/scattered from the surface of the sample 1 which is illuminated with the light from the illumination device 100, a converging lens 132 which causes the light gathered by the objective lens 131 to converge, a pinhole plate 133 which has a pinhole that is placed at a convergence point of the converging lens 132 and causes the converged light to pass therethrough and which blocks out the unconverged light, and a low-angle detector 134 which detects the light that has passed through the pinhole plate 133.

Signals outputted from the detectors 117, 124 and 134 are respectively amplified by A/D converters 141, 142 and 144 and A/D-converted, followed by being input to the processing device 160. On the other hand, a signal obtained by detecting the regular reflection light from the sample 1 by the regular reflection light detector 114 is amplified by an A/D converter 143 and input to the processing device 160.

The processing device 160 is equipped with a production processing section 1610 and an evaluation processing section 1620.

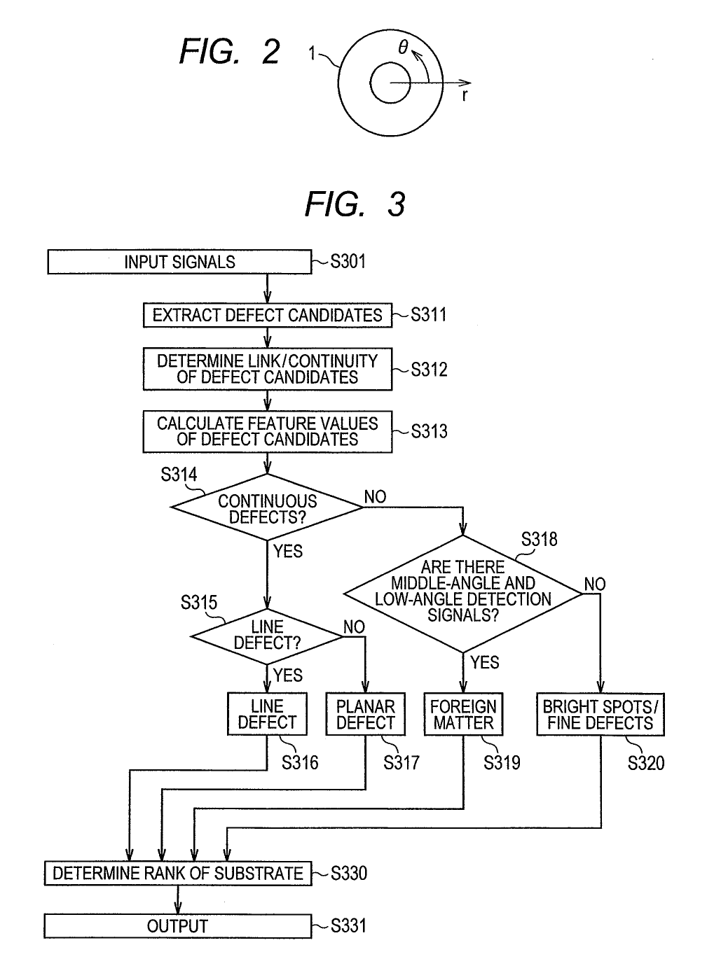

The production processing section 1610 is equipped with a defect candidate extraction unit 1611 which detects defect candidates in response to the signals A/D-converted by the A/D converters 141, 142, 143 and 144 after outputted from the respective detectors 114, 117, 124 and 134, a defect candidate continuity determination unit 1612 which determines a link and/or continuity of the defect candidates detected in response to the signal sent from the defect candidate extraction unit 1611 and positional information (information on rotating direction: θ and radial direction: r, both of which are shown in FIG. 2) on the sample 1 sent from the stage device 190, a defect feature value calculation unit 1613 which calculates the feature value (length, width and area in r direction and/or θ direction) for each of the defect candidates whose link and/or continuity has been determined, a defect classification unit 1614 which classifies defects in response to the signal from the defect feature value calculation unit 1613, and a substrate rank determination unit 1615 which ranks a substrate in response to the result of density of the classified defects.

On the other hand, as with the production processing section 1610, the evaluation processing section 1620 is also equipped with a defect candidate extraction unit 1621 which detects defect candidates in response to the signals A/D-converted by the A/D converters 141, 142, 143 and 144 after outputted from the respective detectors 114, 117, 124 and 134, a defect candidate continuity determination unit 1622 which determines a link and/or continuity of the defect candidates detected in response to the signal sent from the defect candidate extraction unit 1621 and positional information (information on rotating direction: θ and radial direction: r, both of which are shown in FIG. 2) on the sample 1 sent from the stage device 190, a defect feature value calculation unit 1623 which calculates the feature value (length, width and area in r direction and/or θ direction) for each of the defect candidates whose link and/or continuity has been determined, a defect classification unit 1624 which classifies defects in response to the signal sent from the defect feature value calculation unit 1623, and a substrate rank determination unit 1625 which ranks a substrate in response to the result of density of the classified defects.

Here, production inspection recipes set in advance for production have respectively been stored in the defect candidate extraction unit 1611, defect candidate continuity determination unit 1612, defect feature value calculation unit 1613, defect classification unit 1614 and substrate rank determination unit 1615 that are the component units of the production processing section 1610.

Further, evaluation inspection recipes set in advance for evaluation have respectively been stored in the defect candidate extraction unit 1621, defect candidate continuity determination unit 1622, defect feature value calculation unit 1623, defect classification unit 1624 and substrate rank determination unit 1625 that are the respective component units of the evaluation processing section 1620.

Here, data different from each other have been set to the production inspection recipes stored in the respective component units of the production processing section 1610 and to the evaluation inspection recipes stored in the respective component units of the evaluation processing section 1620.

An input/output device 170, which has a display screen 171 and which inputs an inspection condition therein and outputs an inspection result therefrom, is connected to the processing device 160. Further, the processing device 160 and the input/output device 170 are connected to the overall controller 180. The overall controller 180 controls the stage device 190, the illuminating device 100, the processing device 160 and the input/output device 170. The stage device 190 has a stage that rotates the sample 1 placed thereon and that is movable in at least one axis direction within a plane in which the sample 1 is rotated.

With the above configuration, the overall controller 180 controls the stage device 190 to rotate the sample 1 placed thereon and to start moving at a constant speed in one direction (radial direction of sample 1) perpendicular to the center of rotation thereof.

In this state, the illuminating device 100 applies laser onto the surface of the sample 1 rotated on the stage device 190. The regular reflection light of the light reflected/scattered from the surface of the sample 1 and directed toward the high-angle detection optical system 110 is detected by the regular reflection light detector 114, and the scattered light around the regular reflection light is detected by the high-angle detector 117. Further, the scattered light from the surface of the sample 1 and directed toward the middle-angle detection optical system 120 is detected by the middle-angle detector 124, and the scattered light directed toward the low-angle detection optical system 130 is detected by the low-angle detector 134.

This inspection is performed from the outer peripheral portion of the sample 1 to its inner peripheral portion by moving the sample 1 straight while rotating the sample 1, thereby making it possible to inspect the entire surface of the sample 1 on its front side. Further, the sample 1 is reversed using an unillustrated substrate reversing mechanism to turn up its non-inspected backside, and an inspection is performed on the back side surface similar to that performed on the front side surface, so that both surfaces of the sample 1 can be inspected.

Incidentally, in the present embodiment, the pinhole plates 113, 116, 123 and 133 for shielding stray light have respectively been used in the high-angle detection optical system 110, the middle-angle detection optical system 120 and the low-angle detection optical system 130. When, however, a polarizing plate is inserted into the midway of the optical path of laser emitted from the illuminating device 100 to polarize for illuminating the sample 1, polarizing filters may be used instead of the pinhole plates 113, 116, 123 and 133. When a single-wavelength laser is used as the laser emitted from the illuminating device 100, wavelength selection filters may be used instead of the pinhole plates 113, 116, 123 and 133. Further, the polarizing filters and the wavelength selection filters may be used in combination with each other so as to cause light of a specific polarized component having a specific wavelength to pass therethrough.

When a defect on the sample 1 is detected using the inspecting apparatus shown in FIG. 1A, the sample 1 is continuously moved in one direction (X direction) while rotating the sample 1 by the stage device 190. In this state, the laser is emitted to the surface of the sample 1 from the illuminating device.

The reflected/scattered light from the sample 1 irradiated with the laser are respectively detected by the high-angle detection optical system 110, the middle-angle detection optical system 120 and the low-angle detection optical system 130.

The signals outputted from the detectors 114, 117, 124 and 134 and inputted to the A/D converters 141, 142, 143 and 144 respectively are amplified and converted into digital signals, which in turn are inputted to the processing device 160, where they are processed by the production processing section 1610 and the evaluation processing section 1620 simultaneously using different inspection recipes.

A procedure for processing the signals inputted to the production processing section 1610 will first be described using FIG. 3.

The signals outputted from the A/D converters 141 through 144 are inputted to the production processing section 1610 of the processing device 160 (S301). First, at the defect candidate extraction unit 1611, the level of each of the signals inputted from the A/D converters 141 through 144 is compared with a defect decision threshold value set in advance as the production inspection recipe. Each signal of the level that has exceeded the threshold value is extracted as a defect candidate in association with positional information about defect candidate exists on the sample 1 which is obtained from an unillustrated detection system of the stage 190 (rotational angle information of stage 190 and substrate radial-direction positional information) (S311).

Next, the defect candidate continuity determination unit 1612 compares the signal levels with the threshold value for determining the defect area, which has been set in advance as the production inspection recipe, using the positional information about the defect candidates exist on the sample 1 and extracted at the defect candidate extraction unit 1611, and determines the link and/or continuity of the respective defect candidates (S312). Subsequent processing is performed, as one defect, on the defect candidates determined to be present in link and/or continuity.

With respect to the defect candidates determined to be present in link and/or continuity, the defect feature value calculation unit 1613 calculates defect feature values such as the sizes (length in r direction, length in A direction and width of defect) of each defect, its area and the like using the threshold value for determining the defect area, which has been set in advance as the production recipe (S313). At this time, for each defect candidate judged to be present in link and/or continuity at the defect candidate continuity determination unit 1612, the feature value is calculated as one defect.

Finally, the defect classification unit 1614 checks whether the defects whose feature values have been calculated are continuous defects (S314). When it is determined that they are the continuous defects, the defects are checked by using the threshold value set in advance for determining the defect area as the production inspection recipe whether they are a line defect (S315). When the continuous defects do not have an in-plane expansion, the defects are determined to be the line defect (S316). When it is determined that the continuous defects have the in-plane expansion, the defects are determined to be a planar defect (S317).

On the other hand, when the defects are determined not to be the continuous defects at S314, the defects are checked whether they have also been detected by the middle-angle detector 124 and the low-angle detector 134 (S318). When the defects are detected even by the middle-angle detector 124 and the low-angle detector 134, they are judged to be foreign matter defects (S319). When the defects are not detected by the middle-angle detector 124 and the low-angle detector 134, they are determined to be bright spots (fine defects) (S320).

Information about the defects classified in this manner and information about the determination result as to the material of the substrate are sent to the substrate rank determination unit 1615, where the rank of the substrate is determined. That is, when the sample 1 inspected at S304 is of a substrate judged to have a predetermined quality of material, the sample is ranked according to criteria set in advance according to the type and density of the detected defects (S330). The result of ranking thereof is outputted to the input/output device 170 (S331). The input/output device 170 accumulates the results of inspection outputted from the production processing section 1610 and generates a decision list based on the production inspection recipes.

The signals inputted to the evaluation processing section 1620 of the processing device 160 are also processed using the evaluation inspection recipes instead of the production inspection recipes in the same procedure as the processing procedure in the production processing section 1610 described using the flow diagram of FIG. 3. The result of processing thereof is outputted to the input/output device 170. The input/output device 170 accumulates the results of inspection outputted from the evaluation processing section 1620 and generates a decision list based on the evaluation inspection recipes.

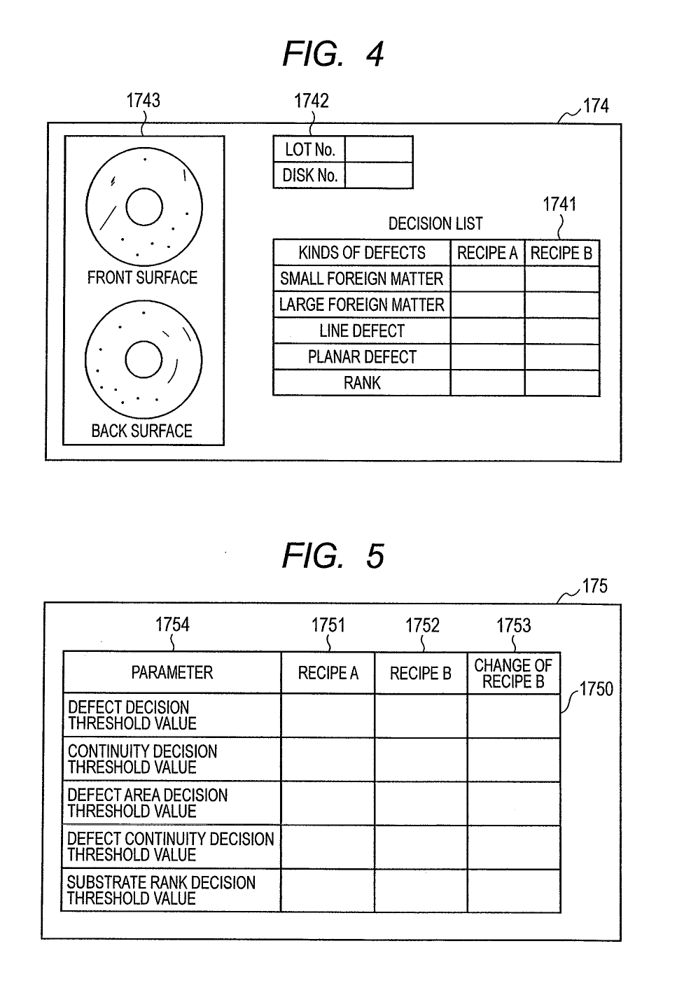

Since the production processing section 1610 and the evaluation processing section 1620 perform the processing simultaneously, the results of their processing are inputted to the input/output device 170 simultaneously. As shown in FIG. 4, a decision list based on a production inspection recipe and a decision list based on an evaluation inspection recipe are displayed side by side on the display screen 174 as a decision list table 1741. Also, a substrate ID display area 1742 is provided on the screen to display a Lot No. of an inspected substrate and a Disk No. for identifying the substrate. Further, the state of distribution of defects detected by the recipes selected on the decision list table 1741 is displayed in a defect distribution display area 1743.

Further, there is shown in FIG. 5, a table 1750 of parameters 1754 for an inspection recipe A (production inspection recipe) 1751 and an inspection recipe B (evaluation inspection recipe) 1752, which is displayed on the display screen 175. In the table display, a corrected value for each inspection recipe B can be inputted to the column 1753 adjacent to the inspection recipe B 1752.

An operator is able to adjust data on the evaluation inspection recipe, based on the decision list decided by using the production inspection recipe 1751 and the decision list decided by using the evaluation inspection recipe 1752, both of which have been displayed side by side on the display screen 175.

Incidentally, it is shown that the examples in which the display screen 174 of FIG. 4 and the display screen 175 of FIG. 5 display the different screens, but the contents of these may be displayed on one screen. Thus, the decision list table 1741 and the parameter table 1750 for the respective recipes can be compared with each other side by side, and hence the data on the inspection recipe B (evaluation inspection recipe) can efficiently be adjusted.

According to the present embodiment, the evaluation inspection recipe can be adjusted while carrying out the inspection continuously without stopping the inspection of the magnetic disk in the production lines. The adjusted evaluation inspection recipe can be used as a new production inspection recipe. As a result, the new production inspection recipe can be generated without significantly degrading the operation rate of the inspecting apparatus.

Incidentally, a button which selects whether to display the evaluation inspection recipe, a button which selects an evaluation inspection recipe to be used when the evaluation inspection recipe is displayed, a button capable of naming the storage destination of evaluation inspection data and the evaluation inspection recipe, and changing the names thereof, etc. may be displayed on the operation screen.

Although the invention made above by the present inventors has been described specifically on the basis of the preferred embodiment, the present invention is not limited to the embodiment referred to above. It is needless to say that various changes can be made thereto within the scope not departing from the gist thereof.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

1. A surface inspecting apparatus having a double recipe processing function, comprising:
a stage device rotatable with a disk as a sample placed thereon and movable in a direction perpendicular to the axis of rotation;
an illuminating device which illuminates the sample placed on the stage device with light;
a first detecting device which detects light reflected/scattered in a first direction from the sample illuminated with the light by the illuminating device;
a second detecting device which detects light reflected/scattered in a second direction from the sample illuminated with the light by the illuminating device;
a processing device which processes a first detection signal obtained by detecting the light reflected/scattered in the first direction form the sample by the first detecting device, and a second detection signal obtained by detecting the light reflected/scattered in the second direction from the sample by the second detecting device so as to detect a defect on the sample; and
an output device which outputs a result of processing performed by the processing device,
wherein the processing device outputs to the output device a result obtained by processing the first detection signal and the second detection signal, based on a first inspection recipe to detect a defect on the sample, and a result obtained by processing the first detection signal and the second detection signal, based on a second inspection recipe to detect a defect on the sample.

2. The surface inspecting apparatus having a double recipe processing function, according to claim 1, wherein the output device outputs for displaying on the screen side by side, the result obtained by processing the first and second detection signals on the basis of the first inspection recipe by the processing device to detect the defect on the sample and the result obtained by processing the first and second detection signals on the basis of the second inspection recipe by the processing device to detect the defect on the sample.

3. A surface inspecting method having a double recipe processing function, comprising the steps of:
illuminating a sample with light while rotating a disk as the sample and moving the same in a direction perpendicular to the axis of rotation;
detecting light reflected/scattered in a first direction form the sample illuminated with the light to obtain a first detection signal;
detecting light reflected/scattered in a second direction from the sample illuminated with the light to obtain a second detection signal; and
processing the first detection signal and the second detection signal to detect a defect on the sample,
wherein the detection of the defect on the sample includes a detection of a defect on the sample by processing the first detection signal and the second detection signal, based on a first inspection recipe and a detection of a defect on the sample by processing the first detection signal and the second detection signal, based on a second inspection recipe.

4. The surface inspecting method having a double recipe processing function, according to claim 3, further including the following step of:
displaying on the screen side by side, the result obtained by processing the first and second detection signals on the basis of the first inspection recipe to detect the defect on the sample and the result obtained by processing the first and second detection signals on the basis of the second inspection recipe to detect the defect on the sample.
